(19) United States
(12) Patent Application Publication
(10) Pub. No.: US 2017/0352045 A1
(43) Pub. Date: Dec. 7, 2017

(54) Cart Activity Sensor Data with Point of Sale Data to Determine Tasks

(71) Applicant: Wal-Mart Stores, Inc., Bentonville, AR (US)

(72) Inventors: Nicholaus A. Jones, Fayetteville, AR (US); Robert J. Taylor, Rogers, AR (US); Aaron J. Vasgaard, Rogers, AR (US); Matthew A. Jones, Bentonville, AR (US)

(21) Appl. No.: 15/611,036

(22) Filed: Jun. 1, 2017

Related U.S. Application Data
(60) Provisional application No. 62/344,073, filed on Jun. 1, 2016.

(51) Int. Cl. G06Q 30/02; G06Q 20/20

(52) U.S. Cl. CPC G06Q 30/0201; G06Q 20/20

(57) ABSTRACT

In some embodiments, systems, apparatuses, and methods are provided herein useful to correlating cart activity with point of sale data. In some embodiments, a system includes one or more sensors, wherein the one or more sensors are configured to gather data associated with cart activity within the shopping facility and a control circuit communicatively coupled to the one or more sensors, the control circuit configured to determine, based on the data from the one or more sensors, the cart activity within the shopping facility, determine, based on point of sale data, items that were purchased, and determine, based on the cart activity within the shopping facility and the items that were purchased, one or more tasks to perform.

### RELATED APPLICATION(S)

This application claims the benefit of U.S. Provisional Application No. 62/344,073, filed Jun. 1, 2016, which is incorporated herein by reference in its entirety.

### TECHNICAL FIELD

This invention relates generally to monitoring guest activity in a shopping facility and, more particularly, to determining cart activity in a shopping facility.

### BACKGROUND

Typically, retailers desire to place products in easy to find locations within a shopping facility. Oftentimes products are grouped logically by type (e.g., grocery, sporting goods, clothing, etc.). Additionally, products can be classified within a group and placed near one another (e.g., in a grocery section, dairy products are placed in a first area, produces in a second area, beverages in a third area, etc.). Although retailers attempt to make products as easy to find as possible, guests may still have difficulty locating certain products. Additionally, it can be beneficial to place products in such a manner that guests may encounter products that they would like to purchase but may not otherwise actively seek. A need exists for a system that can gather and evaluate information that is indicative of whether a product is difficult to find in a shopping facility.

### BRIEF DESCRIPTION OF THE DRAWINGS

Disclosed herein are embodiments of systems, apparatuses and methods pertaining to determining cart movement in a shopping facility. This description includes drawings, wherein:

FIG. 1 depicts a cart 106 being monitored in a shopping facility, according to some embodiments;

FIG. 2 is a diagram of a shopping facility 202 including a cart monitoring system, according to some embodiments;

FIG. 3 is a block diagram of a system 300 for monitoring cart movement in a shopping facility, according to some embodiments;

FIG. 4 is a flow chart including example operations for determining a task to perform based on cart activity, according to some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses, and methods are provided herein useful to determining cart movement in a shopping facility. In some embodiments, a system for correlating cart activity in a shopping facility with point of sale data comprises one or more sensors, wherein the one or more sensors are configured to gather data associated with cart activity within the shopping facility and a control circuit communicatively coupled to the one or more sensors, the control circuit configured to determine, based on the data from the one or more sensors, the cart activity within the shopping facility, determine, based on point of sale data, items that were purchased, and determine, based on the cart activity within the shopping facility and the items that were purchased, one or more tasks to perform.

As previously discussed, the location of products in a shopping facility can have an impact on guest experience and sales. For example, if products are easy to find (e.g., located logically throughout the shopping facility) guests' shopping experiences can be increased due to the ease of finding the products. Additionally, placing products strategically throughout the shopping facility may position products within a guest's path that he or she may want to purchase but would not have actively sought. For example, placing batteries near toys that require batteries may prompt a guest to purchase batteries for a toy he or she is purchasing. Consequently, properly locating products within a shopping facility can increase both guest satisfaction and sales.

According to some embodiments, a system monitors cart activity within a shopping facility. Additionally, the system can monitor point of sale (POS) data and correlate the POS data with the cart activity. Based on the cart activity and POS data, the system can determine tasks to perform. As one example, if the cart activity indicates that many carts have passed a location in which Product X is located but the POS data indicate that few or no guests have purchased Product X (e.g., sales of Product X are below expected or historical averages), it may indicate that Product X needs to be restocked. Based on this correlation, the system can determine that a restocking task should be performed. Alternatively, or additionally, the system can determine that an investigatory task should be performed to determine why guests have not been purchasing Product X (e.g., the price for Product X may be higher than what competitors are charging). As a second example, if the cart activity indicates that few carts have passed a location in which Product Y is located and the POS data indicate that relatively few guests have purchased Product Y, it may indicate that Product Y is poorly located (e.g., Product Y is hard to find, Product Y is not located near other products that complement Product Y, etc.). Based on this correlation, the system can determine that an investigatory task should be performed to determine if Product Y should be relocated within the shopping facility. While this brief overview provides two examples of scenarios that can result in the system determining a task to perform, many other scenarios and tasks exist.

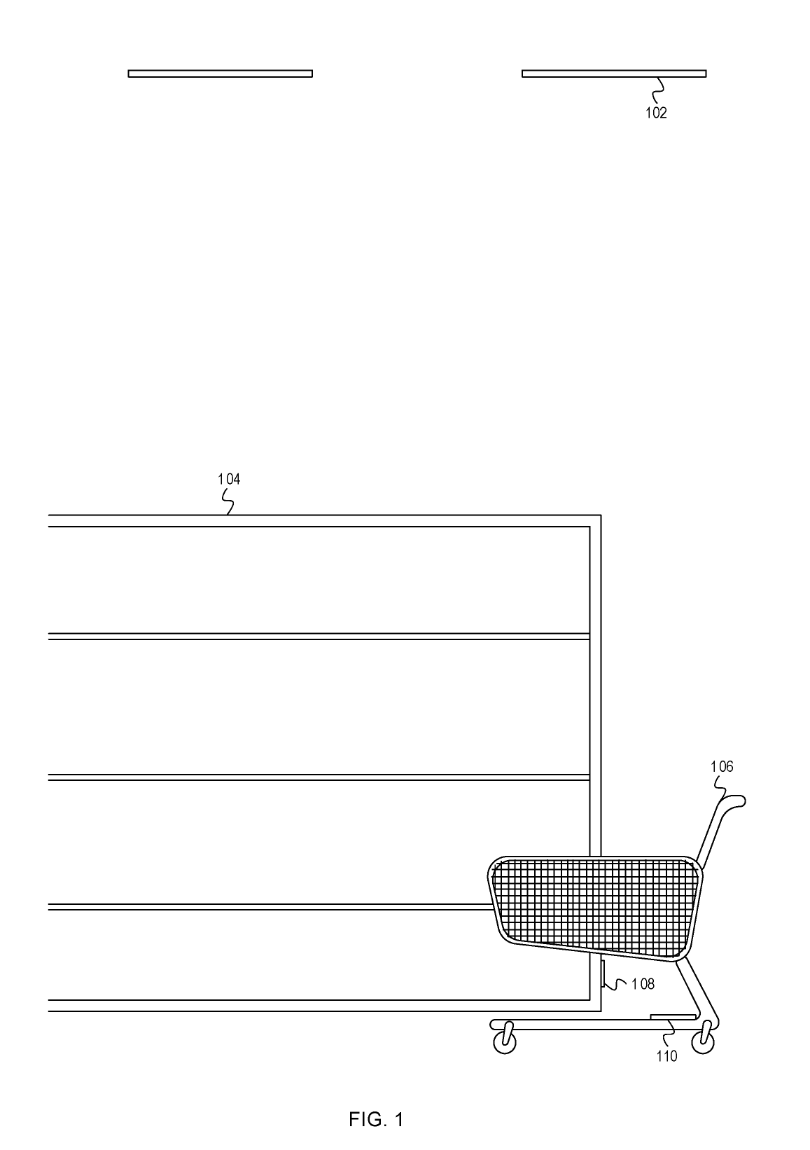

FIG. 1 depicts a cart 106 being monitored in a shopping facility, according to some embodiments. As the cart 106 (and a guest associated with the cart) move throughout the shopping facility, sensors (i.e., first sensors 102 and second sensors 108) monitor the cart's 106 movement throughout the shopping facility. The sensors can be of any suitable type. For example, the sensors can include near field communication (NFC) sensors, radio frequency (RF) sensors, electronic article surveillance (EAS) sensors, dielectric sensors, electrical current sensors, magnetic field sensors, optical sensors, video cameras, still cameras, ultrasonic sensors, microphones, or any other suitable type of sensor.

The sensors can be placed in any suitable location. For example, sensors can be mounted overhead (e.g., mounted in, on, or from the ceiling), such as the first sensors 102 and/or at guest-level (e.g., in fixtures, such as the second sensors 108 located in a product display 104). Dependent upon the location of the sensors, different types of sensors can be used. For example, the second sensors 108 can include magnetic field sensors that form a “gate.” When the cart 106 passes through the “gate,” the cart 106 disrupts that magnetic field and the second sensors 108 perceive the cart. As another example, the first sensors 102 can be video cameras. As the cart 106 moves throughout the store, the video cameras can, possibly in concert with image processing technology, recognize the cart 106 and monitor the cart's 106 movement.

In some embodiments, the cart 106 is uniquely identifiable from other carts in the shopping facility. For example, the cart 106 can include an identifier 110 (e.g., an NFC transponder, an electrical signature, a coded visual pattern, etc.). In such embodiments, the system can monitor movement of the cart 106 within the shopping facility and distinguish the movement of the cart 106 from other carts in the shopping facility. Additionally, the cart 106 can be uniquely identified at checkout. In such embodiments, the system can correlate products associated with the cart 106 (as opposed to other carts) that are purchased as well as the movements of the cart 106 within the shopping facility. The system can uniquely identify the cart 106 at checkout based on the sensors. Alternatively, the system can uniquely identify the cart 106 based on the POS data. For example, the system may not uniquely identify each cart as it moves throughout the shopping facility, but can uniquely identify the cart 106 based on the aggregate cart activity and the products purchased. In any event, the system can be configured to correlate POS data and cart activity with cart-level granularity.

In some embodiments, the system can monitor cart activity generally. That is, the system can monitor the activity of all or multiple carts within the shopping facility without uniquely identifying the carts. For example, the system can correlate POS data and cart activity in the aggregate. Such embodiments may be less costly to implement and offer a clear view of shopping trends within the shopping facility.

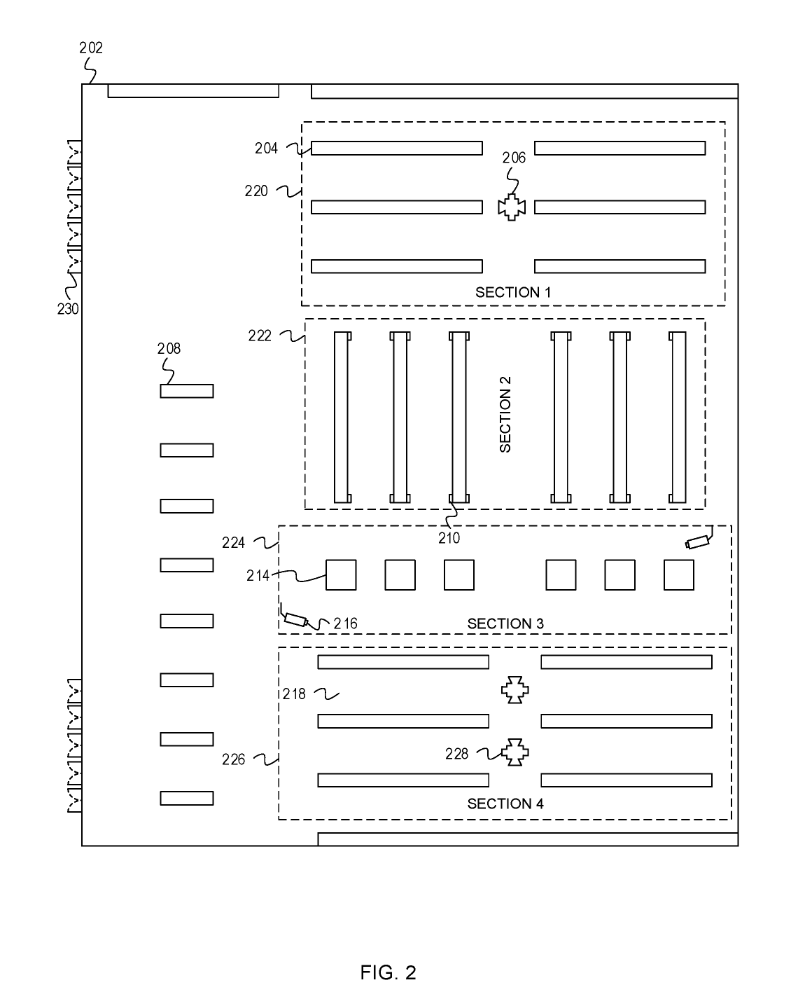

While FIG. 1 and the corresponding text provide an overview of a system for monitoring cart activity in a shopping facility, FIG. 2 and the corresponding text provide an example of sensor placement within a shopping facility.

FIG. 2 is a diagram of a shopping facility 202 including a cart monitoring system, according to some embodiments. FIG. 2 depicts a shopping facility 202 including product displays (i.e., shelves 204 and towers 214), terminals 208, and doors 230. The shopping facility 202 has been divided into sections: a first section 220, a second section 222, a third section 224, and a fourth section 226. Each section includes a different cart monitoring implementation. While each section of FIG. 2 includes a different cart monitoring implementation, such a configuration is not necessary. For example, the shopping facility 202 need not be divided into sections, or each section (or some of the sections) can employ the same cart monitoring implementation. Different configurations can be utilized dependent upon the goal of the system and/or the types of sensors used (e.g., different types of sensors may be better-suited for different types of configurations). In some embodiments, the doors 230 can include sensors to track activity in and out of the shopping facility 202. Additionally, the terminals 208 can include sensors to monitor cart activity and, in some embodiments, aid in uniquely identifying carts and correlating POS data with the uniquely identified carts.

As depicted in FIG. 2, the first section 220 includes a first sensor 206. The first sensor 206 is centrally located within the first section 220 and is capable of monitoring all cart activity within the first section 220. For example, the first sensor 206 can be an RF sensor that reads corresponding RF tags from the carts. As the carts move throughout the first section 220, the first sensor 206 monitors the cart activity. The first sensor 206 can either uniquely identify carts (e.g., via identifiers such as unique RF tags) or simply log cart movement throughout the first section 220 in the aggregate.

As depicted in FIG. 2, the second section 222 includes a plurality of second sensors 210. For example, the second sensors 210 can be located in product displays within the second section 222. The second sensors 210 can act as gates. The second sensors 210 can either uniquely identify the carts as they pass through the gates or simply log cart movement through the gates.

As depicted in FIG. 2, the third section 224 includes a plurality of third sensors 216. The third sensors 216 can be video cameras or still cameras. The third sensors 216 can capture images and/or video continuously, at predetermined intervals, or based upon a trigger (e.g., a motion-related trigger). The third sensors 216 can be positioned strategically so as to detect all cart activity within the third section 224. For example, one of the third sensors 216 can be positioned in each aisle of the third section 224. The third sensors 216 can uniquely identify carts with the aid of software, such as image processing software. Alternatively, or in the event that the third sensors 216 are not able to uniquely identify a cart, the third sensors 216 can monitor cart activity for multiple carts without uniquely identifying the carts.

As depicted in FIG. 2, the fourth section 226 includes a plurality of fourth sensors 228. Each of the fourth sensors 228 is positioned to monitor cart activity in one of the aisles 218. Based on this positioning, each of the fourth sensors 228 can monitor carts as they enter and exit each aisle 218. As with the other sensors, the fourth sensors 228 can be configured to monitor aggregate cart activity and/or monitor carts with cart-level granularity.

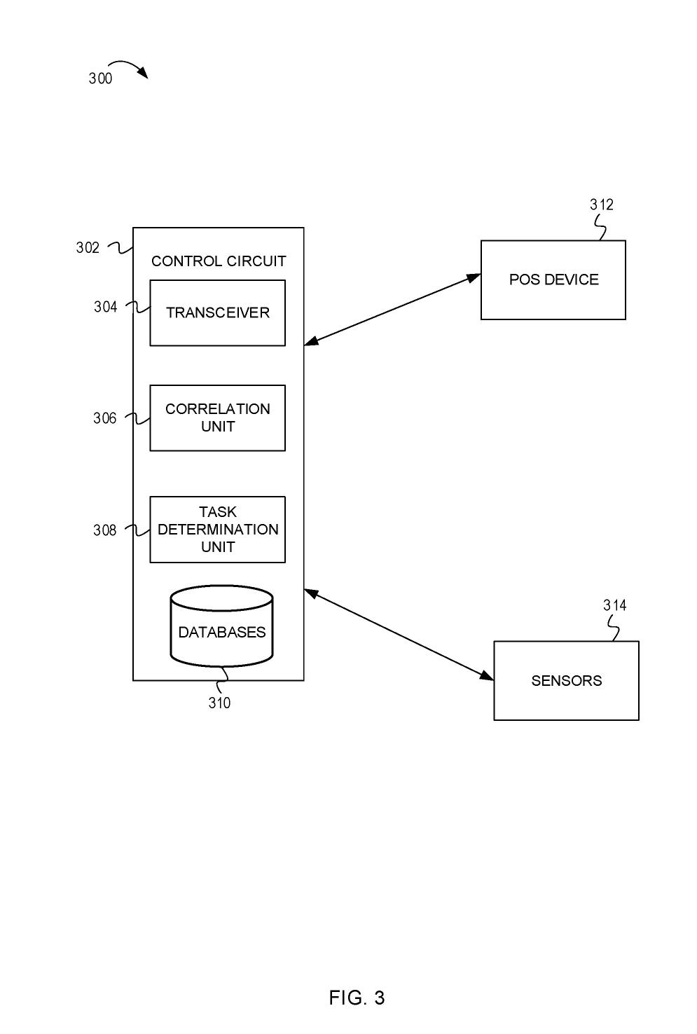

While FIG. 2 and the corresponding text provide an example of sensor placement within a shopping facility, FIG. 3 and the corresponding text describe a cart monitoring system.

FIG. 3 is a block diagram of a system 300 for monitoring cart movement in a shopping facility, according to some embodiments. The system 300 includes a control circuit 302, a point of sale (POS) device 312, and sensors 314. The POS device 312 and the sensors 314 are in communication with the control circuit 302. The POS device 312 and the sensors 314 provide information to the control circuit 302. The POS device tracks sales data (e.g., transaction numbers, products purchased during a transaction, information about transactions, etc.). The sensors 314 monitor cart activity and collect data associated with cart activity. The sensors can monitor the activity with cart-level granularity or monitor aggregate cart activity.

The control circuit 302 includes a transceiver 304, a correlation unit 306, a task determination unit 308, and databases 310. The transceiver 304 receives data from, and transmits data to, the POS device 312 and the sensors 314 (as well as other devices not shown). For example, the transceiver 304 receives POS data from the POS device 312 and an indication of cart activity from the sensors 314. In embodiments in which the sensors 314 uniquely identify the carts, the sensors 314 can also transmit identifiers for the carts.

The correlation unit 306 correlates the cart activity with the POS data. For example, the correlation unit 306 can associate the activity of individual carts with POS data for each cart to correlate the items purchased associated with an individual cart and the activity of the individual cart. Additionally, or alternatively, the correlation unit 306 can associate the activity of multiple carts (e.g., aggregate cart activity) with the POS data. The correlation unit 306 can correlate this information to determine overall trends in buying patterns of guests in the shopping facility. Additionally, in some embodiments, the correlation unit 306 can use a statistical model in concert with the aggregate cart activity and the POS data to, after the fact, uniquely determine where a cart went and what products were purchased in association with that cart. The correlation unit 306 can also determine or estimate an amount of time that a guest was in the shopping facility based on the cart activity and/or the POS data. This information can be used to determine that certain products are difficult to find. For example, the cart activity may indicate that one or more guests traversed a greater portion of the shopping facility, or spent a greater amount of time traversing the shopping facility, than expected based on the items purchased. The correlation unit can compare current data (i.e., an amount of time for a specific guest and POS data for the specific guest) with past guests (e.g., based on the amount of time, time of day, location, items purchased, etc.). The correlation unit 306 can store these comparisons in the databases 310. The databases 310 can include data structures that enhance the efficiency of the system 300. In some embodiments, the databases 310 also include comparisons from other shopping facilities. Additionally, in some embodiments, the databases 310 can include indications of locations of products in the store. The correlation unit 306 can use the databases to analyze product locations in the store based on the cart activity and the POS data. The correlation unit 306 can also compare these analyses with those from other shopping facilities. For example, the correlation unit 306 can compare the amount of time guests spend in the shopping facility compared to other shopping facilities that have products arranged differently, the number of items purchased by guests in the shopping facility compared to other shopping facilities that have products arranged differently, etc. As one specific example, assume that a retailer has multiple shopping facilities, including a first shopping facility and a second shopping facility. The correlation unit 306 can compare the location of a product within the first shopping facility and sales of the product from the first shopping facility with the location of the same product in the second shopping facility and sales of the same product from the second shopping facility. If the sales of the product from the second shopping facility are higher than those of the first shopping facility, it may indicate that the location of the product in the second shopping facility is superior to the location of the product in the first shopping facility.

The task determination unit 308 analyzes the comparisons made by the correlation unit and determines a task to perform. For example, if the correlation unit determined that several guests passed a specific product but did not purchase the product, the task determination unit 308 can determine that a restocking task should be performed based on the assumption that the product is either not stocked or improperly stocked on the product display. As another example, if the correlation unit 306 finds an association between a specific product and guests spending a longer time than expected in the shopping facility (e.g., based on the number of items purchased or cart activity), the task determination unit 308 can determine that an investigatory task should be performed to determine whether the specific product should be moved to a new location. The task to perform can be a general task management task or action (e.g., zoning), a modular task or action (detailed work on a small section of the shopping facility), a product management task or action, a facilities management task or action, a merchandising task or action (e.g., investigate new marketing and/or prices), or any other task or action in the shopping facility. In some embodiments, the databases 310 include a list of tasks and trigger conditions for the tasks. In such embodiments, the task determination unit 308 determines the task to perform by referencing the databases 310. Returning to the example of the previous paragraph, the task determination unit 308 can determine that a product relocation task (i.e., aligning the location of the product in the first shopping facility with the location of the product in the second shopping facility) should be performed.

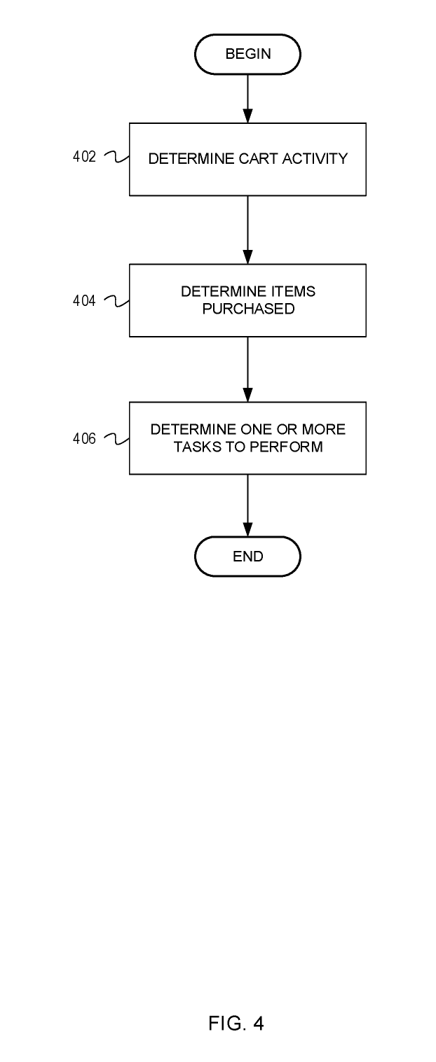

FIG. 4 is a flow chart including example operations for determining a task to perform based on cart activity, according to some embodiments. The flow begins at block 402.

At block 402, cart activity is determined. The cart activity can be determined by sensors or by a control circuit in communication with the sensors. The cart activity can be specific to individual carts or can be aggregate cart activity for multiple carts. The sensors can be of any suitable type. A shopping facility can include only a single type of sensor or multiple types of sensors. Additionally, the sensors can be redundant. For example, a shopping facility can have two sets of sensors in a single area. The sensors can be of the same type and used, for example, to verify cart activity. The sensors can also be of different types and used, for example, to gather different types of information. For example, a shopping facility may have an overhead sensor that monitors aggregate cart activity and in-shelf RF sensors that uniquely identify carts. The data from each of the sensors can be correlated to provide richer cart activity data than may be available if redundant sensors are not used. Additionally, in the case of redundant sensors, the sets of sensors may be individually controllable. For example, in some scenarios it may be useful to utilize only one of the sets of sensors while in other scenarios it might be useful to utilize the other set of sensors or both (or more) sets of sensors. The flow continues at block 404.

At block 404, items that are purchased are determined. For example, the control circuit can determine what products are purchased. The control circuit can make this determination based on POS data. The determination can be made with respect to specific carts or multiple carts. The POS data can include transaction information, such as an indication of the products in each transaction, an identity of a guest associated with each transaction, date and/or time information associated with each transaction, etc. The flow continues at block 406.

At block 406, one or more tasks to perform are determined. For example, the control circuit can determine the one or more tasks to perform. The one or more tasks to perform can be based on the cart activity and/or the POS data. For example, the control circuit can determine the one or more tasks to perform based on a correlation of the cart activity and the POS data. The control circuit can correlate the duration of a current guest with the products purchased, correlate the products purchased with the cart activity, and/or correlate the duration with a total number of products purchased. The task to perform can be a general task management task (e.g., zoning), a modular task (detailed work on a small section of the shopping facility), a product management task, a facilities management task, a merchandising task (e.g., investigate new marketing and/or prices), or any other task in the shopping facility.

Further, in some embodiments, the system can automatically perform the task. For example, if a significant number of guests are passing a particular product but conversion is lower than expected, the system can perform an automated pricing action. The expected sales for the product can be based on the volume of customers, the season, a geographic area, time of day, etc. For example, when a particular produce item is out of season, the expected sales volume for that produce item may be lower than when that produce item is in season. The automated pricing action can be a lowering of the price in an attempt to increase the sales of the product. In some embodiments, the automated pricing action can be based on the product. For example, if the product is perishable, the pricing action can be more aggressive, or greater, than for a product that is nonperishable because of potential losses due to spoilage. Additionally, the pricing action can be tiered. For example, the pricing action can initially decrease the price by a predetermined amount. After a period of time, sales of the product can again be reviewed. If the sales of the product are still below the expected sales, the price can be decreased again. Alternatively, if sales have no increased above the expected amount, the price can be increased.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept. For example, while the discussion of FIG. 1 refers to either uniquely identifying carts or monitoring carts in the aggregate, some embodiments can perform a combination of this monitoring. In such embodiments, some carts can be uniquely identified (e.g., based on an identifier on some of the carts) and monitor other cats in the aggregate. Alternatively, the system might only monitor cart activity in the aggregate but still be able to uniquely identify at least some of the carts. For example, the POS data, in combination with the aggregate cart activity, may be sufficient to uniquely identify some, but not all, of the carts.

In some embodiments, a system for correlating cart activity in a shopping facility with point of sale data comprises one or more sensors, wherein the one or more sensors are configured to gather data associated with cart activity within the shopping facility and a control circuit communicatively coupled to the one or more sensors, the control circuit configured to determine, based on the data from the one or more sensors, the cart activity within the shopping facility, determine, based on point of sale data, items that were purchased, and determine, based on the cart activity within the shopping facility and the items that were purchased, one or more tasks to perform.

In some embodiments, a method for correlating cart activity in a shopping facility with point of sale data comprises determining, based on data from one or more sensors, cart activity within the shopping facility, determining, based on point of sale data, items that were purchased, and determining, based on the cart activity within the shopping facility and the items that were purchased, one or more tasks to perform.

What is claimed is:

1. An automated system to track cart activity and product purchases in a shopping facility, the system comprising:
one or more sensors positioned about the shopping facility, wherein the one or more sensors are configured to collect data associated with cart activity within the shopping facility;
a point of sale system configured to store point of sale data for products located in the shopping facility;
a database configured to store a planogram having product location data defining intended product locations within the shopping facility; and
a control circuit communicatively coupled to the one or more sensors and the point of sale system, the control circuit configured to:
determine, based on the data from the one or more sensors, the cart activity within the shopping facility;
determine, based on point of sale data from the point of sale system, items that were purchased within the shopping facility;
determine, based on the cart activity within the shopping facility, the items that were purchased and product location data from the planogram, that a pricing action should be performed; and
perform, automatically, the pricing action.

2. The system of claim 1, wherein the cart activity within the shopping facility is for a single cart, and wherein the items that were purchased are associated with the single cart.

3. The system of claim 2, wherein the single cart is uniquely identifiable.

4. The system of claim 2, wherein the control is circuit further configured to:
determine, based on the cart activity within the shopping facility, that the single cart passed a location in the shopping facility; and
determine, based on the point of sale data, that the items that were purchased do not include a product that is located at the location.

5. The system of claim 1, wherein the cart activity within the shopping facility includes activity for multiple carts, and wherein the items that were purchased are associated with the multiple carts.

6. The system of claim 5, wherein the control circuit is further configured to:
determine, based on the cart activity within the shopping facility, that at least some of the multiple carts passed a location in the shopping facility; and
determine, based on the point of sale data, that the items that were purchased do not include a product that is located at the location.

7. The system of claim 1, wherein the one or more sensors include one or more of near field communication sensors, electronic article surveillance sensors, dielectric sensors, radio frequency sensors, electrical current sensors, magnetic field sensors, optical sensors, video cameras, still cameras, ultrasonic sensors, and microphones.

8. The system of claim 1, wherein the one or more sensors are positioned one or more of overhead and within product displays.

9. The system of claim 1, wherein each of the one or more sensors is associated with a section.

10. The system of claim 9, wherein each section includes two or more aisles.

11. The system of claim 1, wherein the control circuit is further configured to determine that a pricing action should be performed by referencing a data structure, wherein the data structure includes one or more of possible tasks to perform, POS data for the shopping facility, cart activity for the shopping facility, POS data for other shopping facilities, and cart activity for other shopping facilities.

12. A method for tracking cart activity and product purchases in a shopping facility, the method comprising:
determining, based on data collected by one or more sensors, cart activity within the shopping facility;
determining, based on point of sale data, items that were purchased within the shopping facility;
determining, based on the cart activity within the shopping facility and the items that were purchased and product location data from a planogram, that a pricing action should be performed; and
performing, automatically, the pricing action.

13. The method of claim 12, wherein the cart activity within the shopping facility is for a single cart, and wherein the items that were purchased are associated with the single cart.

14. The method of claim 13, wherein the single cart is uniquely identifiable.

15. The method of claim 13, further comprising:
determining, based on the cart activity within the shopping facility, that the single cart passed a location in the shopping facility; and
determining, based on the point of sale data, that the items that were purchased do not include a product that is located at the location.

16. The method of claim 12, wherein the cart activity within the shopping facility includes activity for multiple carts, and wherein the items that were purchased are associated with the multiple carts.

17. The method of claim 16, the method further comprising:
determining, based on the cart activity within the shopping facility, that at least some of the multiple carts passed a location in the shopping facility; and
determining, based on the point of sale data, that the items that were purchased do not include a product that is located at the location.

18. The method of claim 12, wherein the one or more sensors include one or more of near field communication sensors, electronic article surveillance sensors, dielectric sensors, radio frequency sensors, electrical current sensors, magnetic field sensors, optical sensors, video cameras, still cameras, ultrasonic sensors, and microphones.

19. The method of claim 12, wherein the one or more sensors are positioned one or more of overhead and within product displays.

20. The method of claim 12, wherein each of the one or more sensors is associated with a section.

21. The method of claim 20, wherein each section includes two or more aisles.

22. The method of claim 12, wherein the determining that a pricing actin should be performed includes referencing a data structure, wherein the data structure includes one or more of possible tasks to perform, POS data for the shopping facility, cart activity for the shopping facility, POS data for other shopping facilities, and cart activity for other shopping facilities.
